(19) United States
(12) Patent Application Publication
(10) Pub. No.: US 2025/0384780 A1
(43) Pub. Date: Dec. 18, 2025

(54) AIRCRAFT BASED CLOUD CEILING DETECTION

(71) Applicant: Rockwell Collins, Inc., Cedar Rapids, IA (US)

(72) Inventors: Weston J. Lahr, Sherwood, OR (US); Kevin M. Kronfeld, Cedar Rapids, IA (US); Ross D. Anderson, Lakeville, MN (US); Michael J. Krenz, Roscoe, IL (US)

(21) Appl. No.: 18/741,570

(22) Filed: Jun. 12, 2024

(51) Int. Cl. G08G 5/00; G06V 20/56; G08G 5/02

(52) U.S. Cl. CPC G08G 5/76; G06V 20/56; G08G 5/54

(57) ABSTRACT

A system onboard an aircraft is configured to determine when an aircraft enters or detects a cloud top or cloud base, and record a corresponding altitude. The correlated altitude, location, and time are shared to establish a set of data points corresponding to cloud ceilings and tops. Onboard cameras may be used to identify when the aircraft enters and leaves a cloud. The system correlates the recorded data points to satellite data such as satellite-based cloud images and/or clout top elevations based on location. The correlated images and data points may establish a more complete map of clouds in a wide area. Data points from multiple aircraft may be correlated and combined over time. Data points from multiple aircraft may be shared between aircraft directly or via a network including one or more ground stations.

### BACKGROUND

Cloud ceilings are a critical piece of information for pilots, but such information is not always available. As urban air mobility and unmanned aircraft advances are made, there will be an increasing need for knowing cloud ceilings and cloud tops in more locations.

Currently, automated surface observing system (ASOS) equipment is used to measure cloud ceilings, but ASOS is stationary, typically pointed directly above an airport. As more sites become enabled, deployment of ASOS to each location becomes cost prohibitive. ASOS is also not capable of measuring cloud tops. There is currently no aircraft sensor for identifying clouds ceilings and tops, and no automated method for reporting cloud data to and from aircraft.

It would be advantageous to have accurate cloud ceiling and cloud top data for locations outside of certain fixed locations, as well as cloud top information.

### SUMMARY

In one aspect, embodiments of the inventive concepts disclosed herein are directed to a system onboard an aircraft configured to determine when an aircraft enters or detects a cloud top and/or cloud ceiling, and record a corresponding altitude. The correlated altitude, location, and time are shared to establish a set of data points corresponding to cloud ceilings and tops.

In a further aspect, onboard cameras may be used to identify when the aircraft enters and leaves a cloud.

In a further aspect, the system correlates the recorded data points to satellite data such as satellite-based cloud images and/or clout top elevations based on location. The correlated images and data points may establish a more complete map of clouds in a wide area. Data points from multiple aircraft may be correlated and combined over time. Data points from multiple aircraft may be shared between aircraft directly or via a network including one or more ground stations.

It is to be understood that both the foregoing general description and the following detailed description are exemplary and explanatory only and should not restrict the scope of the claims. The accompanying drawings, which are incorporated in and constitute a part of the specification, illustrate exemplary embodiments of the inventive concepts disclosed herein and together with the general description, serve to explain the principles.

### BRIEF DESCRIPTION OF THE DRAWINGS

The numerous advantages of the embodiments of the inventive concepts disclosed herein may be better understood by those skilled in the art by reference to the accompanying figures in which:

FIG. 1 shows an environmental representation of an aircraft utilizing an exemplary embodiment;

FIG. 2 shows a block diagram of a system suitable for implementing an exemplary embodiment;

### DETAILED DESCRIPTION

Before explaining various embodiments of the inventive concepts disclosed herein in detail, it is to be understood that the inventive concepts are not limited in their application to the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of a feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Also, while various components may be depicted as being connected directly, direct connection is not a requirement. Components may be in data communication with intervening components that are not illustrated or described.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in at least one embodiment” in the specification does not necessarily refer to the same embodiment. Embodiments of the inventive concepts disclosed may include one or more of the features expressly described or inherently present herein, or any combination or sub-combination of two or more such features.

Broadly, embodiments of the inventive concepts disclosed herein are directed to a system onboard an aircraft configured to determine when an aircraft enters or detects a cloud top and/or cloud ceiling, and record a corresponding altitude. The correlated altitude, location, and time are shared to establish a set of data points corresponding to cloud ceilings and tops. Onboard cameras may be used to identify when the aircraft enters and leaves a cloud. The system correlates the recorded data points to satellite data such as satellite-based cloud images and/or clout top elevations based on location. The correlated images and data points may establish a more complete map of clouds in a wide area. Data points from multiple aircraft may be correlated and combined over time. Data points from multiple aircraft may be shared between aircraft directly or via a network including one or more ground stations.

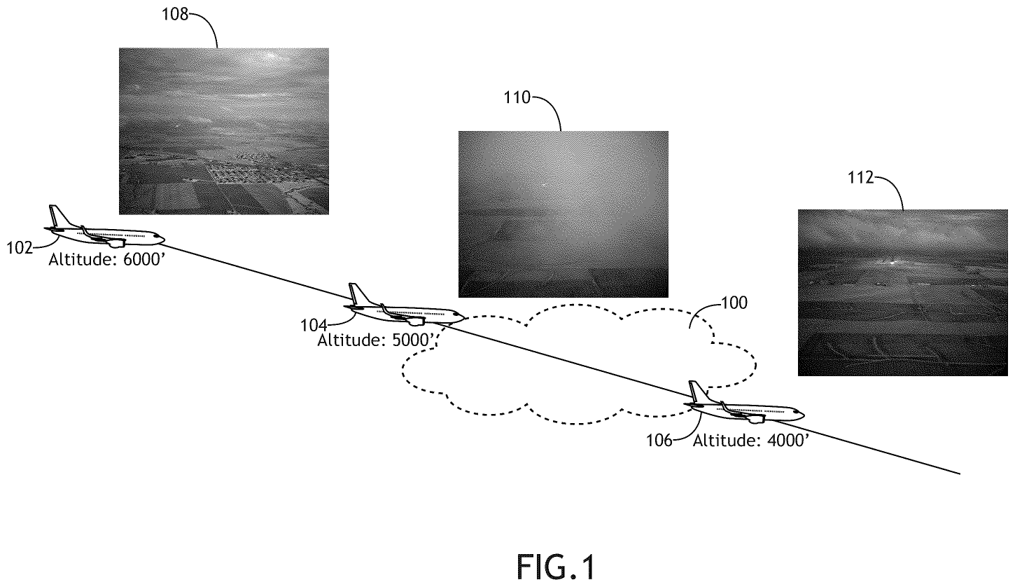

Referring to FIG. 1, an environmental representation of an aircraft utilizing an exemplary embodiment is shown. During flight, an aircraft 102, 104, 106 may transit, or be proximal to, a cloud 100. The aircraft 102, 104, 106 continuously records its altitude. Upon encountering a cloud top (or flying over a cloud where a cloud top may be measured via onboard sensors), the aircraft 104 records its current altitude and current location. Likewise, upon encountering a cloud ceiling, the aircraft 106 also records its current altitude and current location.

The aircraft 102, 104, 106 may share the recorded altitudes and locations with other aircraft and/or ground stations. Either the aircraft 102, 104, 106 or an off-board system may utilize multiple recorded altitudes and locations to map a cloud ceiling and cloud top for a given region.

In at least one embodiment, the aircraft 102, 104, 106 may include image sensors (e.g., cameras) to continuously capture one or more image streams 108, 110, 112. Based on digital image processing, the aircraft 102, 104, 106 may identify when the aircraft 102, 104, 106 enters and exits a cloud.

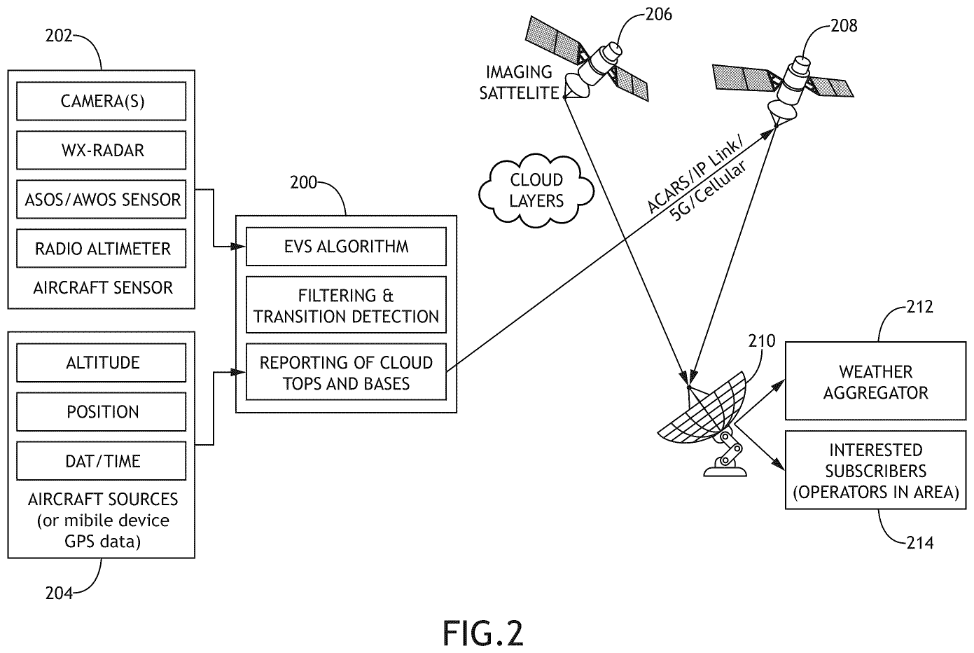

Referring to FIG. 2, a block diagram of a system suitable for implementing an exemplary embodiment is shown. The system may utilize one or more aircraft sensors 202, including image sensors (cameras), weather radar, laser air data sensors, radio altimeters, LIDAR, etc. A processor 200 in data communication with the aircraft sensors 202 may be configured via non-transitory processor executable code to identify cloud ceilings and cloud tops based on the aircraft sensors 202; for example, via an enhanced vision system. Image sensors may include taxi-aid video monitoring systems, runway landing systems, or the like. In at least one embodiment, the processor 200 may receive an indication from a mobile cellular device that the aircraft is entering or leaving a cloud (a crew member may manually indicate a cloud top or cloud base).

In at least one embodiment, the processor 200 may be in data communication with one or more aircraft data sources 204 including stored altitudes, positions, and times. The processor 200 may correlate data from the aircraft sensors 202 and aircraft data sources 204 establish a cloud map or relevant positions, altitudes, and times. The map may then be reported to other aircraft or ground stations 210 (potentially via a satellite 208 datalink). In at least one, embodiment, such ground stations 210 may share such maps with a weather aggregator 212 and/or one or more remote users 214.

In at least one embodiment, the processor 200 or ground station 210 may receive an image stream, from one or more imaging satellites 206, of clouds corresponding to the recorded altitudes, positions, and times. The processor 200 or ground station 210 may determine a cloud type based on the satellite image and recorded altitudes, positions, and times. In at least one embodiment, such determination may be via defined algorithm or a trained neural network or other machine learning algorithm. It may be appreciated that satellite images generally lack sufficient dimensional data to map the cloud vertically; therefore altitude data may be used to provide such dimensionality.

In at least one embodiment, cloud determination may be used to identify active weather worth avoiding. Such determination may be via a remote weather aggregator 212.

In at least one embodiment, the processor 200 may receive ground-based image streams to locate clouds in space.

Embodiments of the present disclosure enable ceiling observations in areas where it is otherwise not available (i.e. smaller airports and locations along flight routes without available ceiling information) to assess flight rule category for departure/takeoff/approach/landing decisions. Higher accuracy in cloud ceiling reporting will provide more accurate flight rules assessment for operators and improve weather data.

Furthermore, embodiments of the present disclosure enable robust contrail prediction through long term machine learning. Likewise, cloud type assessment may be more accurate and robust.

It is believed that the inventive concepts disclosed herein and many of their attendant advantages will be understood by the foregoing description of embodiments of the inventive concepts, and it will be apparent that various changes may be made in the form, construction, and arrangement of the components thereof without departing from the broad scope of the inventive concepts disclosed herein or without sacrificing all of their material advantages; and individual features from various embodiments may be combined to arrive at other embodiments. The forms herein before described being merely explanatory embodiments thereof, it is the intention of the following claims to encompass and include such changes. Furthermore, any of the features disclosed in relation to any of the individual embodiments may be incorporated into any other embodiment.

What is claimed is:

1. A computer apparatus comprising:
at least one processor in data communication with a memory storing processor executable code for configuring the at least one processor to:
continuously receive altitude data corresponding to a present altitude of an aircraft including the computer apparatus;
determine that the aircraft is proximal to a cloud top;
record a first altitude and a first location corresponding to the cloud top and a current altitude and current location of the aircraft;
determine that the aircraft is proximal to a cloud base; and
record a second altitude and a second location corresponding to the cloud ceiling and a current altitude and current location of the aircraft.

2. The computer apparatus of claim 1, wherein the at least one processor is further configured to:
receive a satellite image of a cloud corresponding to the cloud top and the cloud base; and
correlate the first altitude, first location, second altitude, and second location to the satellite image.

3. The computer apparatus of claim 2, wherein the at least one processor is further configured to:
receive a third altitude and a third location corresponding to the satellite image; and
produce a cloud map based on the satellite image, first altitude, first location, second altitude, second location, third altitude, and third location.

4. The computer apparatus of claim 2, wherein the at least one processor is further configured to determine a cloud type based on the satellite image, first altitude, first location, second altitude, and second location.

5. The computer apparatus of claim 1, wherein:
the at least one processor is further configured to receive one or more image streams from one or more onboard image sensors; and
determining that the aircraft is proximal to the cloud top and proximal to the cloud ceiling is with respect to the one or more image streams.

6. The computer apparatus of claim 5, wherein the one or more onboard image sensors comprise cameras in a taxi-aid video monitoring system.

7. The computer apparatus of claim 1, wherein:
the at least one processor is further configured to receive one or more image streams from one or more mobile cellular devices; and
determining that the aircraft is proximal to the cloud top and proximal to the cloud ceiling is with respect to the one or more image streams.

8. A method comprising:
continuously receiving altitude data corresponding to a present altitude of an aircraft;
determining that the aircraft is proximal to a cloud top;
recording a first altitude and a first location corresponding to the cloud top and a current altitude and current location of the aircraft;
determining that the aircraft is proximal to a cloud base; and
recording a second altitude and a second location corresponding to the cloud ceiling and a current altitude and current location of the aircraft.

9. The method of claim 8, further comprising:
receiving a satellite image of a cloud corresponding to the cloud top and the cloud base; and
correlating the first altitude, first location, second altitude, and second location to the satellite image.

10. The method of claim 9, further comprising:
receiving a third altitude and a third location corresponding to the satellite image; and
producing a cloud map based on the satellite image, first altitude, first location, second altitude, second location, third altitude, and third location.

11. The method of claim 9, further comprising determining a cloud type based on the satellite image, first altitude, first location, second altitude, and second location.

12. The method of claim 8, further comprising receiving one or more image streams from the one or more image sensors, wherein determining that the aircraft is proximal to the cloud top and proximal to the cloud ceiling is with respect to the one or more image streams.

13. The method of claim 8, further comprising receiving one or more image streams from one or more mobile cellular devices, wherein determining that the aircraft is proximal to the cloud top and proximal to the cloud ceiling is with respect to the one or more image streams.

14. A system comprising:
one or more image sensors;
at least one data link element; and
at least one processor in data communication with the one or more image sensors, the at least one data link element, and a memory storing processor executable code for configuring the at least one processor to:
continuously receive altitude data corresponding to a present altitude of an aircraft including the computer apparatus;
determine that the aircraft is proximal to a cloud top;
record a first altitude and a first location corresponding to the cloud top and a current altitude and current location of the aircraft;
determine that the aircraft is proximal to a cloud base; and
record a second altitude and a second location corresponding to the cloud ceiling and a current altitude and current location of the aircraft.

15. The system of claim 14, wherein the at least one processor is further configured to:
receive a satellite image of a cloud corresponding to the cloud top and the cloud base; and
correlate the first altitude, first location, second altitude, and second location to the satellite image.

16. The system of claim 15, wherein the at least one processor is further configured to:
receive a third altitude and a third location corresponding to the satellite image; and
produce a cloud map based on the satellite image, first altitude, first location, second altitude, second location, third altitude, and third location.

17. The system of claim 15, wherein the at least one processor is further configured to determine a cloud type based on the satellite image, first altitude, first location, second altitude, and second location.

18. The system of claim 14, wherein:
the at least one processor is further configured to receive one or more image streams from the one or more image sensors; and
determining that the aircraft is proximal to the cloud top and proximal to the cloud ceiling is with respect to the one or more image streams.

19. The system of claim 14, wherein:
the at least one processor is further configured to receive one or more image streams from one or more mobile cellular devices; and
determining that the aircraft is proximal to the cloud top and proximal to the cloud ceiling is with respect to the one or more image streams.

20. The system of claim 14, wherein:
the at least one processor is further configured to:
establish a datalink with at least one ground station via the at least one data link element; and
transmit the first altitude, first location, second altitude, and second location to the ground station; and
the at least one ground station is configured to utilize the first altitude, first location, second altitude, and second location in weather aggregation.
